(19) United States
(12) Patent Application Publication
(10) Pub. No.: US 2020/0249823 A1
(43) Pub. Date: Aug. 6, 2020

(54) SYSTEM AND METHOD OF REORDERING APPS ON A USER INTERFACE

(71) Applicant: DENSO International America, Inc., Southfield, MI (US)

(72) Inventor: Jeffrey TURK, South Lyon, MI (US)

(21) Appl. No.: 16/263,933

(22) Filed: Jan. 31, 2019

(51) Int. Cl. G06F 3/0484; G06F 3/0482; G06F 3/0488; B60K 35/00; G06F 3/16

(52) U.S. Cl. CPC G06F 3/04845; G06F 3/0482; G06F 3/04883; B60K 2350/1044; G06F 3/167; B60K 2350/1004; B60K 2350/1028; B60K 35/00

(57) ABSTRACT

According to one embodiment, a user interface of a device comprising a display configured to output information related to a user interface of the multimedia system, wherein the user interface includes one or more icons indicative of an application of the multimedia system, and a processor in communication with the display and programmed to in response to a first input from a user, allow an arrangement of the one or more icons on the user interface and adjust an original size of the icons to a smaller size, set the arrangement of the one or more icons and adjust the smaller size icons to the original size icons, and output the original size icons on the display with the arrangement.

### TECHNICAL FIELD

The present disclosure relates to user interfaces, such as those user interfaces on a mobile device or a vehicle multimedia system.

### BACKGROUND

User interfaces may be utilized to activate execution of applications. As a user loads more applications on their device or system, organization may be necessary of the applications. The applications may require reorganization to better suit a user over time.

### SUMMARY

According to one embodiment a multimedia system in a vehicle, comprising a display configured to output information related to a user interface of the multimedia system, wherein the user interface includes one or more icons indicative of an application of the multimedia system, and a processor in communication with the display and programmed to in response to a first input from a user, allow an arrangement of the one or more icons on the user interface and adjust an original size of the icons to a smaller size, and in response to a second input from a user, set the arrangement of the one or more icons and adjust the smaller size icons to the original size icons, and output the original size icons on the display.

According to one embodiment, a method of arranging icons on a user interface, comprising outputting on display one or more icons of the user interface, wherein the one or more icons are organized in a first arrangement, receiving a first input from a user, shrinking the one or more icons from an original size of the icon to a smaller size of the icon, in response to the first input, allowing arrangement of the one or more icons on the user interface in response to the first input, setting a second arrangement of the one or more icons, and output the original size icons with the second arrangement on the display.

According to one embodiment, a user interface of a device comprising a display configured to output information related to a user interface of the device, wherein the user interface includes one or more icons indicative of an application of the device, and a processor in communication with the display and programmed to in response to a first input from a user, allow an arrangement of the one or more icons on the user interface and adjust an original size of the icons to a smaller size, set the arrangement of the one or more icons and adjust the smaller size icons to the original size icons, and output the original size icons on the display with the arrangement.

### BRIEF DESCRIPTION OF THE DRAWINGS

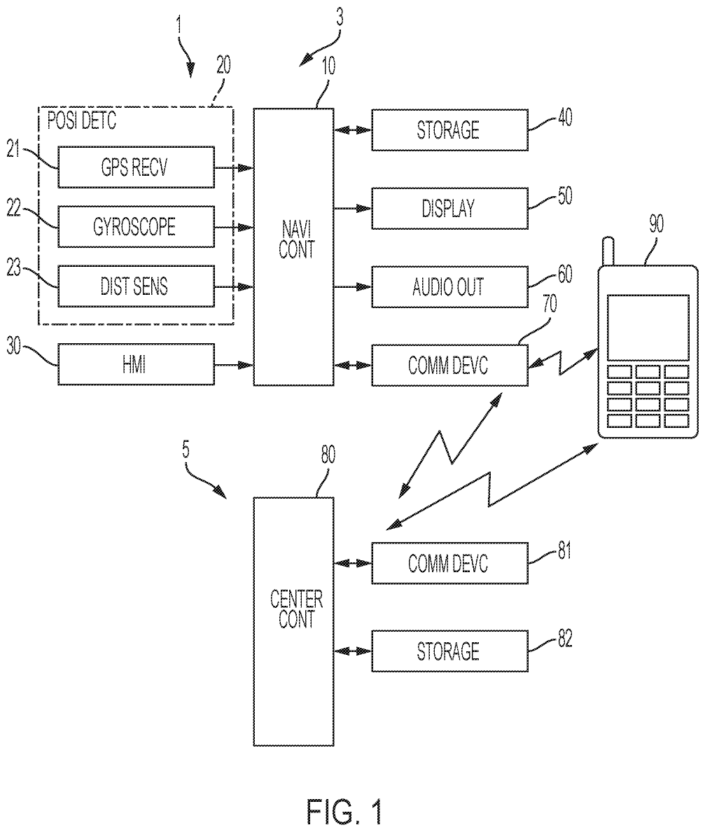

As shown in FIG. 1, a vehicle system 1 includes a navigation apparatus 3 and a data center 5.

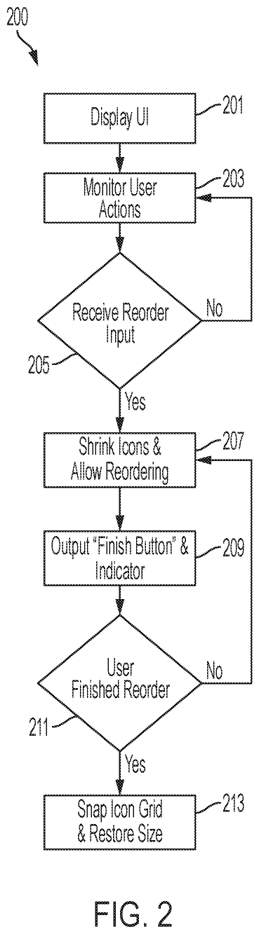

As shown in FIG. 2, an exemplary flowchart 200 regarding a user interface configured to allow re-ordering of applications.

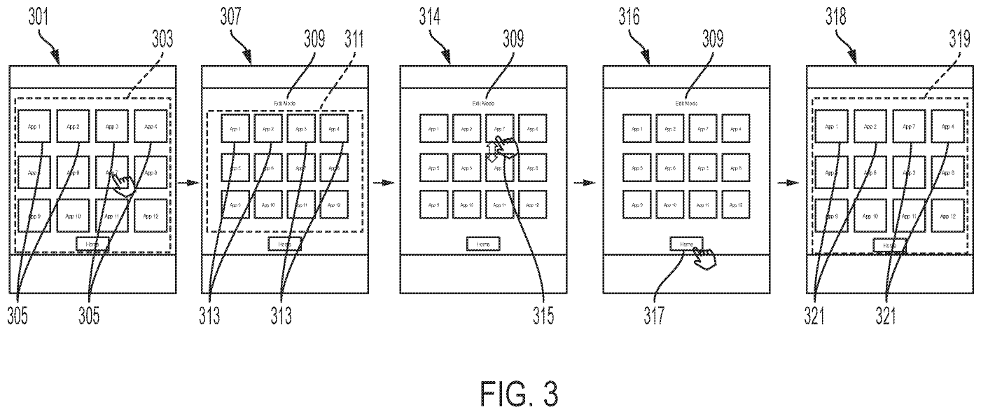

As shown in FIG. 3, an exemplary screen-flow diagram regarding a user interface configured to allow re-ordering of applications.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A user interface may include a “HOME” screen or many different screens. Some systems may allow for re-ordering of application icons that are listed on a HOME screen or multiple screens. The embodiment disclosed below may allow for screen resizing when the application icons are reduced in size. For example, when the interface allows for the apps to be reordered, the screen icons may reduce in size by 25%. This may allow for passengers to perform the editing operation faster because the drag distance is shorter. It also may be intuitive to the user to understand that the screen has entered the re-ordering mode/screen since such an embodiment communicates that the system has entered in such a special mode. The app order that is set may be saved with a profile associated with a user. There may be an option to change the app size to a larger icon that allows people to see the icons easier in case they have bad vision.

As shown in FIG. 1, a vehicle system 1 includes a navigation apparatus 3 and a data center 5. The navigation apparatus 3 may be equipped in a vehicle and may include a navigation controller (NAVI CONT) 10 or processor. The navigation apparatus may be a portable terminal, such as a smart phone having a navigation function, other than a device equipped to a vehicle. The navigation apparatus may also be an off-board server or system that processes directions and maneuvers off-board that are to be sent to the vehicle. The route may be calculated using a remote service place and pushed into the vehicle storage. The navigation could be played as audio messages or visual indications (e.g. icons). Local position detectors (either on-board or off-board) may be utilized to match car's position to the route info. The navigation controller 10 may include a microcomputer, which has a central processing unit (CPU), a read only memory (ROM), a random-access memory (RAM), an input/output (I/O) interface and a bus line for coupling the CPU, the ROM, the RAM and the I/O interface. The navigation controller 10 may include a position detector (POSI DETC) 20, a user interface or human machine interface (HMI) 30, a storage 40, a display screen (DISPLAY) 50, an audio output device (AUDIO OUT) 60, and a communication device (COMM DEVC) 70. The position detector 20 may detect a present position of the vehicle. The user interface 30 may be used for inputting a command from a user to the navigation apparatus 3 or vehicle system 1. The storage 40 may store map data. The display screen 50 may display a map and various information to the user. The audio output device 60 may output audio guidance and sounds to occupants of the vehicle. The communication device 70 of the navigation apparatus 3 may communicate with an off-board server 5. Furthermore, the communication device 70 (or another communication device, such as a wireless transceiver as a Bluetooth transceiver), may be utilized to communication with a mobile device 90, such as a mobile phone. The mobile device 90 may be utilized for handsfree communication or other capabilities based on interoperability with the vehicle system 1.

The position detector 20 may receive signals transmitted from satellites for a global positioning system (GPS). The position detector 20 may include a GPS receiver (GPS RECV) 21, a gyroscope (DIST SENS) 22, and a distance sensor (DIST SENS) 23. The GPS receiver 21 may detect a position coordinate and an altitude of the present position of the vehicle. The gyroscope 22 outputs a detection signal corresponding to an angular velocity of a rotational motion applied to the vehicle. The distance sensor 23 outputs a traveling distance of the vehicle. The navigation controller 10 calculates the present position, a direction, and a velocity of the vehicle based on signals output from the GPS receiver 21, the gyroscope 22, and the distance sensor 23. Further, the present position may be calculated in various methods based on the output signal from the GPS receiver 21. For example, a single point positioning method or a relative positioning method may be used to calculate the present position of the vehicle.

The HMI 30 or user interface 30 includes a touch panel and may include mechanical key switches. The touch panel is integrally set with the display screen 50 on the display screen or located away from the display such as in front of an arm rest. The mechanical key switches are arranged around the display screen 50. When the navigation apparatus 3 provides a remote-control function, operation switches for the remote control function are arranged in the HMI 30. The HMI 30 may also include a voice recognition system that utilizes voice prompts to operate various vehicle functions. The HMI 30 may also include a haptic device or similar device that allows a user to control and operate the system. The HMI 30 may also include a voice recognition system, remote touchpad, or utilize a stylus pen.

The storage 40, in which the applications and map data is stored, inputs various data included in the map data to the navigation controller 10. The various data includes road data, facility data, point-of-interest (POI) data, address book data, and guidance data. The road data is indicative of a road connection status, and includes node data, which indicates a predetermined position such as an intersection, and link data, which indicates a link that connects adjacent nodes. The facility data is indicative of a facility on the map. The guidance data is used for route guidance. Address book data may be utilized to store custom contacts, locations, and other information (e.g. home or work). POI data may be utilized to identify a POI's location, contact information, category information, review (e.g. Zagat or Yelp) information, etc. Examples of a POI may be a McDonald's under the category of a fast-food restaurant; Starbuck's under coffee shop, a Holiday Inn under the category of hotel, etc. Other POI examples may include, hospitals, dealerships, police stations, cleaners, etc. POIs may be independent business or corporate businesses. The storage 40 may be configured to be rewritable in order to update various applications, software, operating system, and the user interface of the vehicle. For example, a hard disk drive (HDD) and a flash memory may be used as the storage 40.

The display screen 50 may be a color display apparatus having a display surface such as a liquid crystal display. The display screen 50 displays various display windows according to video signal transmitted from the navigation controller 10. Specifically, the display screen 50 displays a map image, a guidance route from a start point to a destination, a mark indicating the present position of the vehicle, and other guidance information. The display screen 50 may also be a touch screen interface that allows for a user to interact with an operating system, software, or other applications via interaction with the screen. The audio output device 60 may output audible prompts and various audio information to the user. With above-described configuration, the route guidance can be performed by displaying viewable information on the display screen 50 and outputting audible information with the audio output device 60.

The communication device 70 may communicate data with the “cloud,” for example, a data center 5. Specifically, the navigation apparatus 3 may be wirelessly coupled to a network via the communication device 70 so that the navigation apparatus 3 performs the data communication with the data center 5. The communication device 70 may be an embedded telematics module or may be a Bluetooth transceiver paired with mobile device 90 utilized to connect to remote servers or the “cloud.” The communication device 70 may be both a Bluetooth communication or another form of wireless (or wired) communication.

The server 5, which is remote from the vehicle, mainly includes a data center controller (CENTER CONT) 80. Similar to the navigation controller 10, the data center controller 80 mainly includes a well-known microcomputer, which has a CPU, a ROM, a RAM, an input/output interface and a bus line for coupling the CPU, the ROM, the RAM and the I/O interface. The data center controller 80 includes a communication device (COMM DEVC) 81, a first storage (FIR STORAGE) 82. The communication device 81 of the data center 5 performs the data communication with the navigation apparatus 3. Specifically, the data center 5 is wirelessly coupled to the network via the communication device 81 so that the data center 5 performs the data communication with the navigation apparatus 3.

As shown in FIG. 2, an exemplary flow chart 200 may show a user interface configured to allow re-ordering of applications on a home screen or application screen. The flow chart 200 may be indicative of a process carried out by a processor or controller that is found in a vehicle, such as a vehicle multimedia system. The exemplary processor or controller may also be found in a smart phone, tablet, laptop, point of sale display, touch display, or other mobile device or touch screen interface. At step 201, the system may be utilized to display a user interface (also known as human machine interface, or “HMI”). As mentioned above, the user interface may be that of any type of system.

At step 203, the system may monitor the user actions on the user interface. Such actions may include activation of the various functions in the vehicle or on a mobile device. However, the system and interface may have a “HOME” screen that includes icons indicative of applications. The system may also have various other screens (e.g. additional pages of icons) that include icons indicative of applications, that upon activation of the icon, the application may launch. The system may also have a specific command (e.g. specified user input) that will allow the icons to be reordered. The system may monitor for such actions.

At step 205, the system may determine if it has received input from a user (e.g. user himself or device controlled by a user) that activates the ability for the user interface to reorder the icons indicative of the application. In one example, a “press-and-hold” command may be an activation hold (e.g. “press”) of an icon for a time (e.g. 1.5 seconds) and then a release. In one embodiment, a press-and-hold of the icon on the display may be a physical press of a finger of the user. Upon release of the “hold,” activation or initiation of a function may occur in such an interface. A press-and hold of the icon may also be a press-and-hold of a mouse-like interface, a haptic device, stylus pen, remote pad interface, etc. For example, a user may press and hold on a haptic device that allows interaction of the user interface via movement of the haptic device. Upon release of the “hold,” activation or initiation of a function (e.g. the shrinking/re-arrangement interface of the application) may be initiated. There may also be an embodiment that allows the input for activation of the rearrangement mode to be from a voice recognition command. In such an embodiment, the user may initiate a voice recognition engine and speak a command to act as the input to activate the ability for the user interface to reorder the icons. Such a command may be speech from the user saying “REORDER APPLICATIONS,” “ACTIVATE REARRANGEMENT MODE,” etc.

At step 207, the user interface may have received the activation of the reorder interface which may shrink the size of the icons and allow for the icons to be reordered. The icons may be reordered by allowing a user to drag the icons across a display or screen of the system. The “drag” may refer to a press, hold, and drag via a touch input or other device controlled by a user. In an embodiment, the system may have sounds associated with a “drag” of the application icon to notify the user that the icon is being re-arranged. The system may also allow for the removal of applications (e.g. deleting the applications) in such a mode, which would inherently change some arrangement of the icons since any deletion will result in less icons being displayed.

At step 209, the user interface may output a “FINISH” button/switch and/or indicator allowing the user to know the system is in a rearrangement mode. There may be a “FINISH” button that allows a user to set the changes made during the rearrangement mode and exit the rearrangement mode to normal use. The “FINISH” button may include any text or icon, rather simply saying “FINISH” or “FINISHED.” For example, there may be a “HOME” button or a button with a symbol of a HOME. The system may also notify the user of entering the rearrangement mode by outputting an indicator (e.g. a title) or by change a color of the screen or border. In another embodiment, the system may notify a user they are in edit mode or rearrangement mode utilizing a chime or another sound. For example, an audible voice may state and output that the interface is in an “edit mode.”

At step 211, the system may analyze if the user finished reordering the applications. The reordering may be completed by utilizing a button press of the “FINISH” button/switch. The system processor or controller may be programmed to identify when such a button or switch has been activated. In another embodiment, the system may not require activation of such a “FINISH” button/icon/switch but may timeout after a certain threshold time is exceeded. Such a threshold time may be relatively long threshold amount (e.g. 15 seconds, 20 seconds, 30 seconds, etc.). In yet another embodiment, the system may utilize a voice recognition command to finish the reorder. A user may speak the command (e.g. occupant says “REARRANGEMENT COMPLETE” or “FINISHED REORDERING”, or other commands, etc.).

At step 213, the system may restore the size of the icons and then lock-in the locations of the icons for use in response to the second input received indicating the user is complete with the rearrangement. Thus, the reordering may be complete, and the interface will allow activation of icons under normal operation, as opposed to the rearrangement. In other words, the system may exit the rearrangement mode and set the new icon's arrangement and enter into normal-operation mode.

As shown in FIG. 3, an exemplary screen-flow diagram regarding a user interface configured to allow re-ordering of applications. A first screen 301 may be shown. In such a screen, a user may be presented with a plurality of icons 305. In the screen 301, there may be twelve different icons 305 shown. The icons 305 may utilize a certain screen area 303. The icons may be utilized to execute an application that are loaded in memory of a multimedia system or a mobile device. The user interface may have multiple pages with grids of app icons utilized to organize the applications on a device or multimedia system.

A second screen 307 may be shown as part of the user interface. In an embodiment, the second screen may be in response to a first input from a user. The first input may be a press and hold of one of the icons 305. In response to the input from the user, the icons may shrink in size, as shown by the smaller icons 313. The smaller icons 313 may take up a smaller screen area 309 during the second screen. The smaller icons 313 may stay small and allow for arrangement until a timeout period or a second input. The timeout period may be a threshold hold time of no interaction from a user on the user interface. The threshold time may be set by a time, such as 1 second, 2 seconds, 1.5 seconds, etc. The second screen 307 may also show an indicator 309 that notifies the user that the icons may be arranged. For example, the indicator 309 may display that the screen can be edited. For example, the indicator 309 may be text that displays “EDIT MODE.”

A third screen 314 of the screen flow diagram shows that a motion 315 from the input may allow the application icons to be rearranged. The third screen 314 may show an indicator 309, such as text that displays “Edit Mode.” In one scenario, the system may be utilized in a vehicle with safety measures that only allows the re-ordering of the application when the vehicle speed is below a certain threshold speed (e.g. 5 MPH). In another scenario, the system may allow reordering of the icons at any speed if the system detects that a passenger is operating the user interface. Such detection may be utilized by cameras or seat sensors. When the smaller icons 313 are being rearranged, the system may move the smaller icons in a fixated area of the grid 309 to show where the smaller icons 313 will be arranged when the rearrangement is complete.

A fourth screen 316 exemplifies that the user may be finished editing the arrangement of the smaller size icons. The screen 316 may be a moment of the user interface where a user has finished arranging the smaller icons 313, but has not let the user interface know it is done with the arrangement. The user may be able to finish the arrangement by pressing a “HOME” icon 317. The “HOME” icon 317 may also include different text or a symbol than “HOME,” as explained above. As indicated in FIG. 3, a user may press the icon 317 to indicate that it is finished arranging the smaller icons 313. In an alternative embodiment, rather than pressing the “HOME” icon 317, the system may have a threshold time that would set the arrangement, as explained above.

A fifth screen 318 may allow the system to snap the grid in place and restore the icons to the original screen size. As shown on the fifth screen 318, the rearranged application icons 321 may be restored. The fifth screen may have a screen area 319 for the icons 321 that have been rearranged. The screen area 319 may be the same size as the screen area 303 for the first screen 301. Upon the system snapping the re-arranged application icons (normal size) 321, a user may be able to activate the icons for loading. If the user chooses to rearrange the applications, the system would revert back to the second screen 307.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A multimedia system in a vehicle, comprising:
a display configured to output information related to a user interface of the multimedia system, wherein the user interface includes a plurality of icons indicative of an application of the multimedia system; and
a processor in communication with the display and programmed to:
in response to a first input from a user, allow an arrangement of the plurality of icons on the user interface and adjust an original size of each of the plurality of icons to a smaller size, wherein all icons of the user interface are adjusted to the smaller size; and
in response to a second input from a user, set the arrangement of the plurality of icons and adjust each of the smaller size icons to the original size of the plurality of icons, and output the original size plurality of icons on the display, wherein all icons of the user interface are outputted to the original size.

2. The multimedia system of claim 1, wherein the first input from the user is a press-and-hold of the icon on the display.

3. The multimedia system of claim 1, wherein press-and-hold of the icon on the display includes a press-threshold time of one second or more.

4. The multimedia system of claim 1, wherein the processor is further programmed to revert the arrangement when a threshold time is exceeded that the processor does not receive the second input from a user.

5. The multimedia system of claim 1, wherein the processor is further programmed to revert the arrangement if a threshold time is exceeded that the processor does not receive the second input from a user.

6. The multimedia system of claim 1, wherein the original size of the icons is more than 50% larger than the smaller size icons.

7. The multimedia system of claim 1, wherein the original size of the icons is more than 25% larger than the smaller size icons.

8. The multimedia system of claim 1, wherein the display is a touch display.

9. The multimedia system of claim 1, wherein the first input from the user and the second input from the user are different types of inputs.

10. A method of arranging icons on a user interface, comprising:
outputting on display a plurality of icons of the user interface, wherein the plurality of icons are organized in a first arrangement;
receiving a first input from a user;
shrinking the plurality of icons from an original size to a smaller size, in response to the first input, wherein all icons of the user interface are adjusted to the smaller size;
allowing arrangement of the plurality of icons on the user interface in response to the first input;
setting a second arrangement of the plurality of icons; and
output the plurality of icons to the original size with the second arrangement on the display, wherein all icons of the user interface are output as the original size.

11. The method of arranging icons of claim 10, wherein the method further includes expanding the plurality of icons from the smaller size of the icon to the original size of the icon in response to a second input.

12. The method of arranging icons of claim 10, wherein the method further includes outputting an indicator in response to the first input.

13. The method of arranging icons of claim 12, wherein the method further includes removing the indicator in response to a second input.

14. The method of arranging icons of claim 10, wherein the method further includes expanding the plurality of icons from the smaller size to the original size in response to a threshold time being exceeded.

15. The method of arranging icons of claim 14, wherein the threshold time is two or more seconds.

16. The method of arranging icons of claim 10, wherein the first input from the user is a press and hold.

17. A user interface of a device, comprising:
a display configured to output information related to a user interface of the device, wherein the user interface includes a plurality of icons indicative of an application of the device; and
a processor in communication with the display and programmed to:
in response to a first input from a user, allow an arrangement of the plurality of icons on the user interface and adjust an original size of the plurality of icons to a smaller size;
set the arrangement of the plurality of icons and adjust the smaller size to the original size; and
output the plurality of icons at the original size on the display with the arrangement.

18. The user interface of claim 17, wherein the processor is further programmed to revert the arrangement when a threshold time is exceeded that the processor does not receive a second input from a user.

19. (canceled)

20. (canceled)

21. The multimedia system of claim 1, wherein the processor is further programmed to move the smaller icons to a fixated area of a grid to output where the smaller icons will be arranged upon the second user input.

22. The multimedia system of claim 1, wherein the plurality of icons includes all of the icons on the user interface.
